(19) United States
(12) Patent Application Publication
(10) Pub. No.: US 2016/0016145 A1
(43) Pub. Date: Jan. 21, 2016

(54) PORTABLE ON-DEMAND SULFUROUS ACID GENERATOR

(71) Applicant: ALEXIS DANIEL GONZALEZ, Whittier, CA (US)

(72) Inventor: ALEXIS DANIEL GONZALEZ, Whittier, CA (US)

(21) Appl. No.: 14/335,469

(22) Filed: Jul. 18, 2014

(51) Int. Cl. B01J 19/24; C01B 17/48

(52) U.S. Cl. CPC B01J 19/24; C01B 17/48; B01J 2219/24

(57) ABSTRACT

Some embodiments of the present disclosure include a portable sulfurous acid generator for producing sulfurous acid on-demand for, for example, a small-scale irrigation system. The sulfurous acid generator may include a hopper for storing an amount of elemental sulfur, a supply chute for transporting the sulfur from the hopper to a burn chamber, wherein the burn chamber is configured to burn the elemental sulfur, producing sulfur dioxide fumes, a Venturi system operatively connected to the burn chamber, the Venturi system configured to transport the fumes from the burn chamber into a holding tank comprising a fluid, creating a sulfurous acid solution, and a pump configured to recirculate the fluid in the system. A user may dispense sulfurous acid from the holding tank into an irrigation system using a dispensing valve, and the sulfurous acid generator may be mounted on a support platform for portability.

### BACKGROUND

The embodiments herein relate generally to agricultural equipment, and more particularly, to a portable, on-demand sulfurous acid (H₂SO₃) generator.

When irrigating agricultural resources with existing water sources, the optimum water pH level for optimum nutrient uptake and production of crops is not available. Thus, it is desired to add sulfurous acid to the water to lower its pH to the desired level for irrigation purposed. Conventionally, sulfurous acid generators are stationary and require large volumes of water to operate. Small farmers cannot utilize the conventional sulfurous acid generators because of portability issues and the large volume of water required to operate the conventional sulfurous acid generators.

Therefore, what is needed is a potable on-demand sulfurous acid generator that can be used for pH adjustment of irrigation water.

### SUMMARY

Some embodiments of the present disclosure include a portable sulfurous acid generator for producing sulfurous acid on-demand for, for example, a small-scale irrigation system. The sulfurous acid generator may include a hopper for storing an amount of elemental sulfur, a supply chute for transporting the sulfur from the hopper to a burn chamber, wherein the burn chamber is configured to burn the elemental sulfur, producing sulfur dioxide fumes, a Venturi system connected to the burn chamber, the Venturi system configured to transport the fumes from the burn chamber into a holding tank comprising a fluid, creating a sulfurous acid solution, and a pump configured to recirculate the fluid in the system.

### BRIEF DESCRIPTION OF THE FIGURES

The detailed description of some embodiments of the invention is made below with reference to the accompanying figures, wherein like numerals represent corresponding parts of the figures.

FIG. 1 is a front perspective view of one embodiment of the present invention.

FIG. 2 is a rear perspective view of one embodiment of the present invention.

FIG. 3 is a section view of one embodiment of the present invention, taken along line 3-3 in FIG. 2.

FIG. 4 is a section view of one embodiment of the present invention, taken along line 4-4 in FIG. 1.

FIG. 5 is a flow chart of one embodiment of the present invention.

FIG. 6 is a continuation of FIG. 5.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a portable, on-demand sulfurous acid generator for lowering the pH in irrigation water and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.
1. Hopper
2. Burn Chamber
3. Pump
4. Holding Tank
5. Venturi System

The various elements of the portable, on-demand sulfurous acid generator for lowering the pH of irrigation water of the present disclosure may be related in the following exemplary fashion. It is not intended to limit the scope or nature of the relationships between the various elements and the following examples are presented as illustrative examples only.

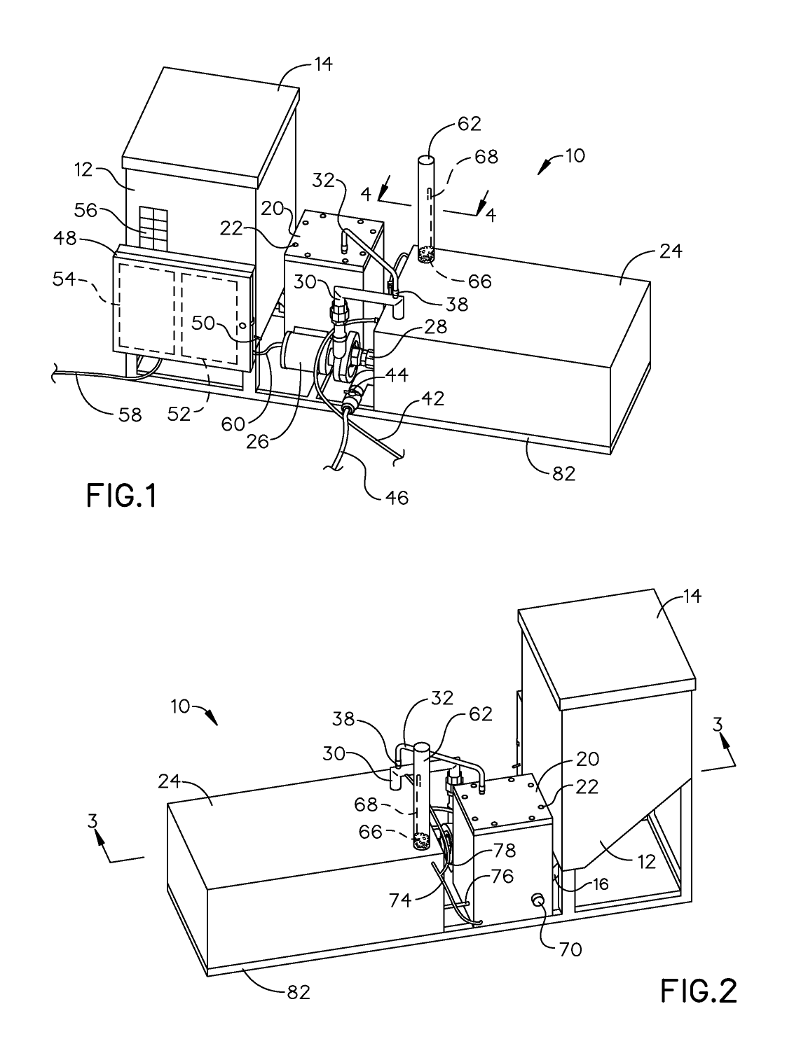

By way of example, and referring to FIGS. 1-6, some embodiments of the sulfurous acid generator 10 of the present disclosure comprise a hopper 12 connected to a burn chamber 18 by, for example, a supply chute 16, the hopper 12 configured to hold an amount of fuel 88, such as elemental sulfur, the chute 16 configured to transport the fuel 88 from the hopper 12 to the burn chamber 18, a water supply hose 42 configured to supply fluid 90, such as water, to a holding tank 24, the holding tank 24 being connected to the burn chamber 18 by, for example, Venturi system connection 38, the holding tank 24 configured to hold a volume of fluid 90, such as sulfurous acid, and the Venturi system connection 38 configured to transport the fumes from the ignited fuel 88 from the burn chamber 18 to the holding tank 24 creating a sulfurous acid solution. The generator 10 may further comprise a pump 26 connected to holding tank 24, the pump 26 being configured to recirculate the fluid 90 in the generator 10, and a dispensing valve 44 for dispensing the fluid 90 as needed. The sulfurous acid generator 10 of the present disclosure may be mounted on a support platform 82 for portability.

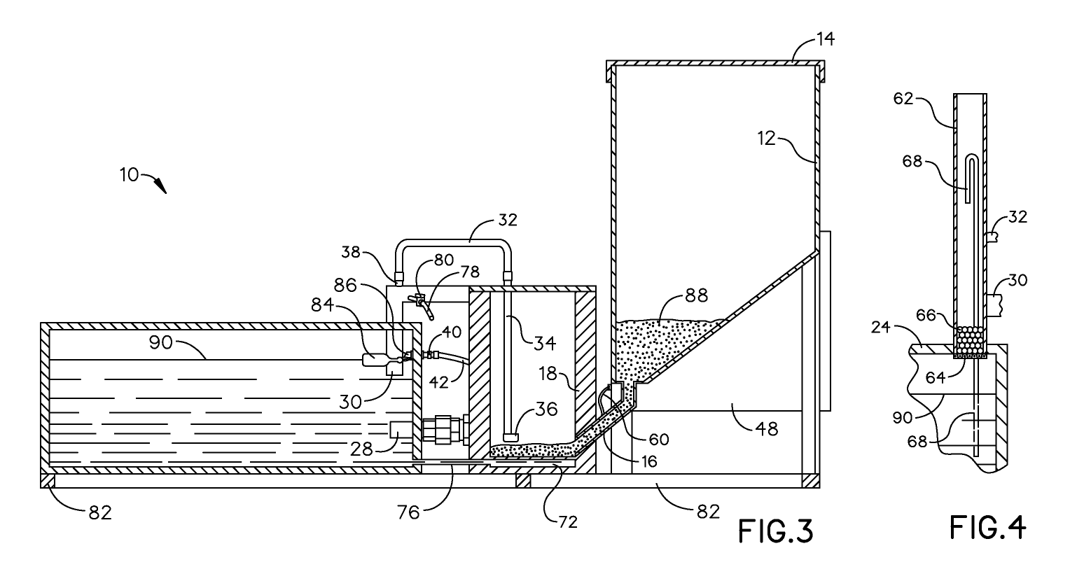

The hopper 12 may comprise a structure with a hopper lid 14, wherein the hopper 12 may be configured to store a volume of fuel 88, such as elemental sulfur. The supply chute 16 may be attached to a bottom-most surface of the hopper 12 and may attach the hopper 12 to the interior of the burn chamber 18, as shown, for example in FIG. 3. To an outer surface of the hopper 12 may be attached a solar panel 56 and a switching system box 48. However, the solar panel 56 and the system switching box 48 may also be attached at any other desired location. The switching system box 54 may comprise a battery 54, a transformer 52, and a switch 50, wherein when a user positions the switch 50 to the “on” position, the portable sulfurous acid generator 10 of the present disclosure may be powered on. Specifically, the pump 26 may receive power through the pump power supply cords 60 when the switch 50 is in the “on” position. The solar panel 56 may be operatively connected to the switching system box 54 to provide power to the switching system box 54. Alternatively, the switching system box 54 may receive power from an external source via a power supply cord 58.

The burn chamber 18 may comprise a burn chamber lid 20, which may be secured using a fastener, such as burn chamber lid screws 22, and an ignition port 70, wherein the burn chamber 18 may be operatively connected to the holding tank 24 by, for example, a Venturi system connection 38. The fuel 88 in the burn chamber 18 may be ignited through the ignition port 70. The burn chamber 18 may further comprise a safety overflow cup 36, which may prevent the system from malfunctioning if too much fuel 88 is fed into the burn chamber 18. The Venturi system connection 38 may draw the fumes from the burning fuel 88 through a burn chamber exhaust pipe 34 in the burn chamber 18 and continuously transport and mix the fumes with water in the holding tank 24. The Venturi system 38 may draw oxygen from the atmosphere through the ignition port 70 using a removable gas transfer tube 32 to keep the fuel 88 in the burn chamber 18 ignited.

The Venturi system connection 38 may attach to a pump outflow pipe 30 which transports water (initially) and sulfurous acid (after time) from the pump 26 to the holding tank 24, wherein positive pressure may be created and maintained in the holding tank 24 by the atmospheric air drawn in by the Venturi system, which may force excess unused SO₂ gases out of the holding tank through an exhaust pipe 62. As shown in FIG. 4, the exhaust pipe may comprise a scrubbing system, such as a system comprising an exhaust pipe screen 64, scrubbing spheres 66, and a misting tube 68, wherein the excess SO₂ gases may pass through the exhaust pipe screen 64 and the scrubbing spheres 66 and be sprayed with water from the misting tube 68 such that SO₂ recovery may occur, reintroducing the SO₂ into the fluid 90 stored in the holding tank 18. A pump inflow pipe 28 may simultaneously withdraw fluid 90 from the holding tank 24 to recirculate the fluid 90 through the pump 26 and back out the pump outflow pipe 30 into the holding tank 24. Thus, the pump 26 may be a recirculation pump. The pump 26 may also recirculate the fluid 90 from the holding tank 24 through a heat transfer input hose 74 into a heat transfer chamber 72 and back out through a heat transfer output hose 76 to the holding tank 24 and the Venturi system connection 38 through a heat transfer hose 78, wherein the heat transfer chamber 72 is configured to maintain the temperature in the burn chamber 18 at a relatively stable and constant temperature when the system is operating.

The holding tank 24 may comprise a float 84 attached to a float valve 86, which in turn may be attached to a float valve connection 40 on the water supply hose 42, wherein the level of the fluid 90 may be maintained by way of the float 84 and float valve 86. Specifically, when the fluid 90 in the holding tank 24 is too low, the float 84 and float valve 86 may cause the water supply hose 42 to add water into the holding tank 24. Alternatively, if the level of the fluid 90 is too high, the float 84 and float valve 86 may prevent water from water from entering the system through the water supply hose 42. The fluid 90 generated by the system may be dispensed from the holding tank 18 through a dispensing valve 44, which may be attached to a dispensing hose 46, as needed. Shutdown of the system may be achieved by cutting power to the pump 26 by, for example, positioning the switch 50 in the “off” position.

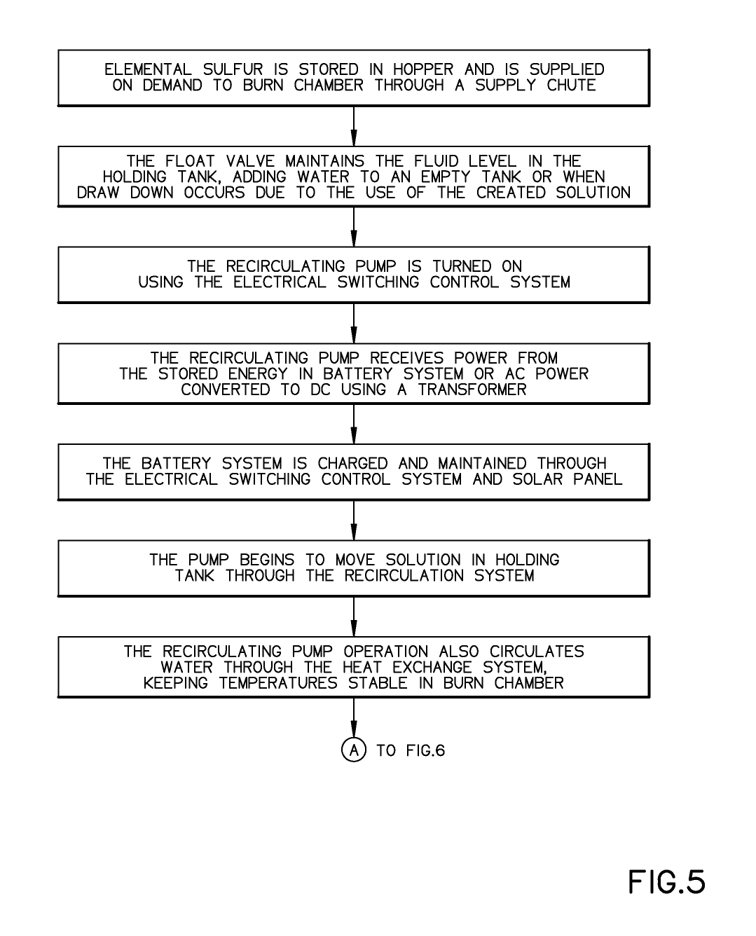

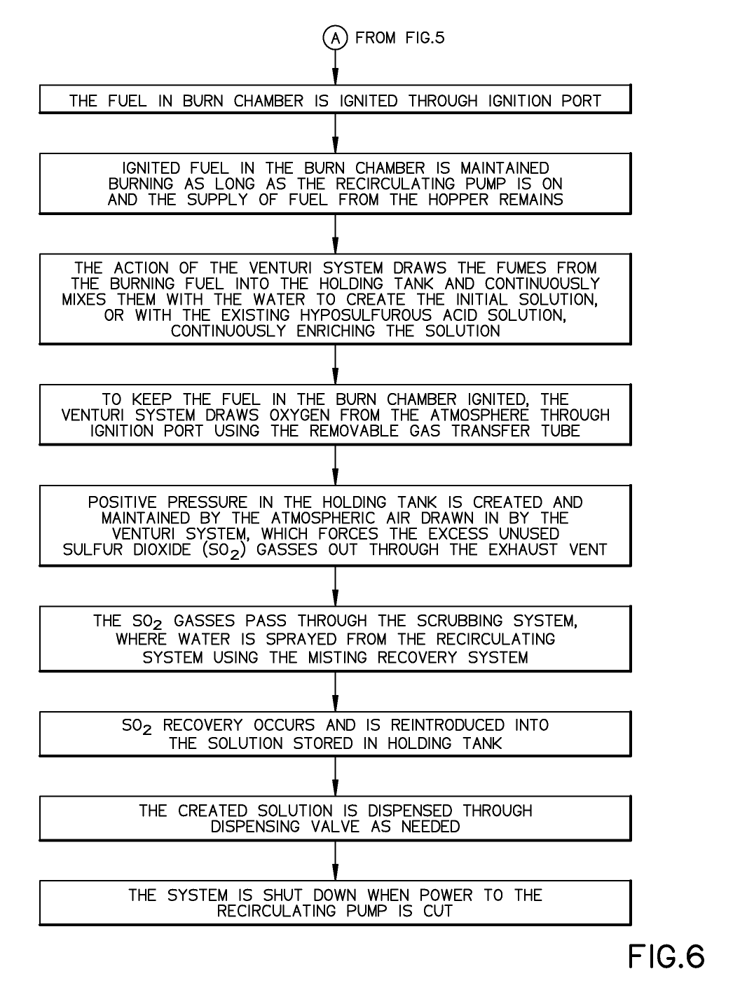

As shown FIGS. 5 and 6, the sulfurous acid generator 10 of the present disclosure may operate in the following manner. Elemental sulfur (fuel 88) may be inserted into and stored within the hopper 12, wherein the elemental sulfur 88 may be supplied on demand to the burn chamber 18 through a supply chute 16. Simultaneously, a float valve 86 may maintain the level of the fluid 90 in the holding tank 24, adding water from the water supply hose 42 to an empty holding tank 24 or when draw down occurs due to use of the created fluid 90, for example, sulfurous acid. A user may turn the pump 26 on by using the electrical switching system, which may include switch 50. The pump 26 may receive power from the stored energy in a battery system 54 or AC power converted to DC power using a transformer 52. The battery system 54 may be charged and maintained through the use of the electrical switching control system and a solar panel 56. When the power is supplied to the pump 26, the pump 26 may begin to (i) move the fluid 90 in the holding tank through the recirculation system, and (ii) circulate water through the heat exchange system, including the heat transfer chamber 72, keeping the temperature in the burn chamber 18 at a substantially constant temperature.

The fuel 88 in the burn chamber 18 may be ignited by a user through the ignition port 70, wherein the ignited fuel 88 in the burn chamber 18 may be maintained burning as long as the pump 26 is supplied with power and the hopper 12 continues providing the burn chamber 18 with fuel 88. The Venturi system may draw the fumes from the burning fuel 88 into the holding tank 24, continuously mixing the fumes with (i) water to create an initial solution 90, or (ii) existing fluid 90, such as sulfurous acid, continuously enriching the solution. To keep the fuel 88 in the burn chamber 18 ignited, the Venturi system may draw oxygen from the atmosphere through the ignition port 70 using a removable gas transfer tube 32. Positive pressure in the holding tank 24 may be created and maintained by the atmospheric air drawn in by the Venturi system, which may force the excess unused sulfur dioxide (SO₂) gases out of the holding tank 24 through the exhaust vent 62. The SO₂ gases may then pass through a scrubbing system, where water may be sprayed from the recirculation system using a misting recovery system or misting tube 68. As a result, SO₂ recovery may occur, and SO₂ may be reintroduced into the fluid 90 stored in the holding tank 24. The resulting fluid, which may be, for example, sulfurous acid, may be dispensed through the dispensing valve 44, as needed. When a user is done using the portable sulfurous acid generator 10 of the present disclosure, the user may turn the power to the system off using, for example, the switch 50.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A portable sulfurous acid generator for producing sulfurous acid, the portable sulfurous acid generator comprising:
a hopper configured to store an amount of elemental sulfur;
a burn chamber attached to the hopper by a supply chute, the supply chute configured to transport the elemental sulfur from the hopper to the burn chamber, wherein the burn chamber is configured to burn the elemental sulfur, producing sulfur dioxide fumes;
a Venturi system operatively connected to the burn chamber, the Venturi system configured to transport the fumes from the burn chamber into a holding tank comprising a fluid, creating a sulfurous acid solution; and
a pump configured to recirculate the fluid in the holding tank.

2. The portable sulfurous acid generator of claim 1, wherein power is provided to the pump from at least one member selected from the group consisting of a battery charged by a solar panel and a transformer.

3. The portable sulfurous acid generator of claim 1, wherein the portable sulfurous acid generator is mounted on a support platform.

4. The portable sulfurous acid generator of claim 1, wherein:
the Venturi system comprises a Venturi system connection attached to a pump outflow pipe which is configured to transport at least one member selected from the group consisting of water and sulfurous acid from the pump to the holding tank; and
positive pressure is created and maintained in the holding tank by atmospheric air drawn in by the Venturi system, forcing excess sulfur dioxide gases out of the holding tank through an exhaust pipe.

5. The portable sulfurous acid generator of claim 4, wherein the exhaust pipe comprises a scrubbing system comprising:
an exhaust pipe screen;
scrubbing spheres; and
a misting tube,
wherein:
the excess sulfur dioxide gases pass through the exhaust pipe screen and the scrubbing spheres and are sprayed with water from the misting tube, resulting in sulfur dioxide recovery; and
the recovered sulfur dioxide is reintroduced into the fluid in the holding tank.

6. The portable sulfurous acid generator of claim 1, further comprising a dispensing valve extending from the holding tank, wherein the dispensing valve is configured to dispense the fluid from the holding tank to a desired area external of the sulfurous acid generator.

7. The portable sulfurous acid generator of claim 1, further comprising:
a pipe outflow pipe configured to transport the fluid from the pump to the Venturi system; and
a pipe inflow pipe configured to transport the fluid from the holding tank to the pump.

8. The portable sulfurous acid generator of claim 1, further comprising:
a heat transfer input hose attaching the holding tank to a heat transfer chamber, the heat transfer input hose configured to transport fluid from the holding tank to a heat transfer chamber; and
a heat transfer output hose attaching the heat transfer chamber to the holding tank, the heat transfer output hose configured to transport fluid from the heat transfer chamber to the holding tank; and
a heat transfer output hose attaching the heat transfer chamber to the Venturi system, the heat transfer output hose configured to transport fluid from the heat transfer chamber to the Venturi system,
wherein the heat transfer chamber is configured to maintain the temperature in the burn chamber at a substantially constant temperature,

9. The portable sulfurous acid generator of claim 1, further comprising a switch, wherein:
the switch is configured to complete a circuit supplying power to the pump when the switch is in an “on” position; and
the switch is configured to break the circuit supplying power to the pump when the switch is in an “off” position.

10. The sulfurous acid generator of claim 1, wherein a level of the fluid in the holding tank is maintained by a float valve.
